(19) United States
(12) Patent Application Publication
(10) Pub. No.: US 2007/0017310 A1
(43) Pub. Date: Jan. 25, 2007

(54) Vehicle control system

(75) Inventors: Haruki Matsuzaki, Obu-city (JP); Tomoyuki Kashiwagi, Chita-gun (JP); Masaaki Shinojima, Chiryu-city (JP); Takuya Tamaru, Kariya-city (JP); Masashi Hori, Anjo-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/472,421

(22) Filed: Jun. 22, 2006

(30) Foreign Application Priority Data
Jun. 30, 2005 (JP) 2005-191592

(51) Int. Cl. F16H 61/00; B60K 17/04

(52) U.S. Cl. 74/335; 74/473.12

(57) ABSTRACT

A vehicle control system is used for an automatic transmission that is operated in accordance with a shift range position switched by a passenger. The vehicle control system includes an actuator and a control circuit. The actuator operates the shift range position. The control circuit controls the actuator such that the shift range position coincides with an instruction provided by the passenger. The actuator and the control circuit are integrated.

### CROSS REFERENCE TO RELATED APPLICATIONS

This application is based on and incorporates herein by reference Japanese Patent Application No. 2005-191592 filed on Jun. 30, 2005.

### FIELD OF THE INVENTION

The present invention relates to a vehicle control system.

### BACKGROUND OF THE INVENTION

In general, a shift-by-wire system includes an actuator such as an electric motor for driving a shift range switchover valve to switch over a shift range position of an automatic transmission. In such a shift-by-wire system, a shift range position cannot be switched over when an actuator or a control circuit for controlling the actuator causes a failure. According to each of U.S. Pat. No. 5,094,115 (JP-A-3-255252) and U.S. Pat. No. 6,230,576 (JP-A-2000-170905), a shift-by-wire system has a redundant dual system, in which components are partially or entirely doubled.

According to US '115, an operating device (shift-by-wire system) has dual actuators and control circuits, so that the shift-by-wire system is capable of switching over a shift range position even when either the actuator or the control circuit causes a failure. According to US '576, a shift range switchover device (shift-by-wire system) has dual coils and drive circuits, so that the shift-by-wire system is capable of switching over a shift range position even when either one of the drive circuits causes a failure. However, in the above structures of the shift-by-wire systems, the number of components may be increased. Consequently, the shift-by-wire systems are made large in size due to increase in the number of components.

In general, actuators and control circuits are generally designed to have margins in load, voltage, and electric current. Accordingly, it is less frequently caused that an operation becomes impossible due to failure of an actuator and a control circuit themselves. A major factor causing a serious defect in operation is a trouble caused in a conductor or a connector, which electrically connects the actuator with the control circuit.

FIG. 12 is a schematic view showing a comparative example of a shift-by-wire system 90. An actuator 91 connects with a control circuit 92 via a wire harness 93 as a conductor. A failure may be mainly caused due to defects in contact and fitting of a connector in shift-by-wire system 90. The connector may connect the actuator 91 with the wire harness 93, or may connect the control circuit 92 with the wire harness 93. Alternatively, a failure may be mainly caused due to breakage or short circuit arising in the wire harness 93 when components of the vehicle pinch the wire harness 93 therebetween.

In addition, assembly works are necessary for connecting an actuator with a control circuit via a conductor and for laying the conductor. Accordingly, variation may be caused in manufacturing quality.

### SUMMARY OF THE INVENTION

In view of the foregoing and other problems, it is an object of the present invention to produce a vehicle control system that is high in reliability.

According to one aspect of the present invention, a vehicle control system, which is for an automatic transmission, includes an actuator that manipulates the automatic transmission to switch a shift range position of the automatic transmission. The vehicle control system further includes a control circuit that controls the actuator such that the shift range position coincides with an instruction provided by the passenger. The actuator and the control circuit are integrated.

Alternatively, an automatic transmission system for a vehicle includes an automatic transmission. The automatic transmission system further includes an actuator that operates a shift range position of the automatic transmission. The automatic transmission system further includes a control circuit that controls the actuator such that the shift range position coincides with an instruction provided by a passenger. The actuator includes a housing that accommodates the control circuit.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic sectional view showing an electric motor according to a first embodiment;

FIG. 2A is a schematic view showing a rotor core and a stator core of the electric motor, and FIG. 2B is a plan view showing the rotor core and the stator core;

FIG. 3 is a schematic view showing an interior of a housing of the electric motor;

FIG. 4 is a schematic view illustrating switching elements in the housing;

FIG. 5 is a schematic lateral view showing a shift-by-wire system including the electric motor and an automatic transmission;

FIG. 6 is a schematic perspective view showing the shift-by-wire system and the electric motor;

FIG. 7 is a schematic sectional view showing an electric motor according to a second embodiment;

FIG. 8 is a schematic sectional view showing an electric motor according to a third embodiment;

FIG. 9 is a schematic sectional view showing an electric motor according to a fourth embodiment;

FIG. 10 is a schematic sectional view showing an electric motor according to a fifth embodiment;

FIG. 11 is a schematic sectional view showing an electric motor according to a sixth embodiment; and

FIG. 12 is a schematic lateral view showing a shift-by-wire system according to a comparative example.

### DETAILED DESCRIPTION OF PREFERRED EMBODIMENTS

### First Embodiment

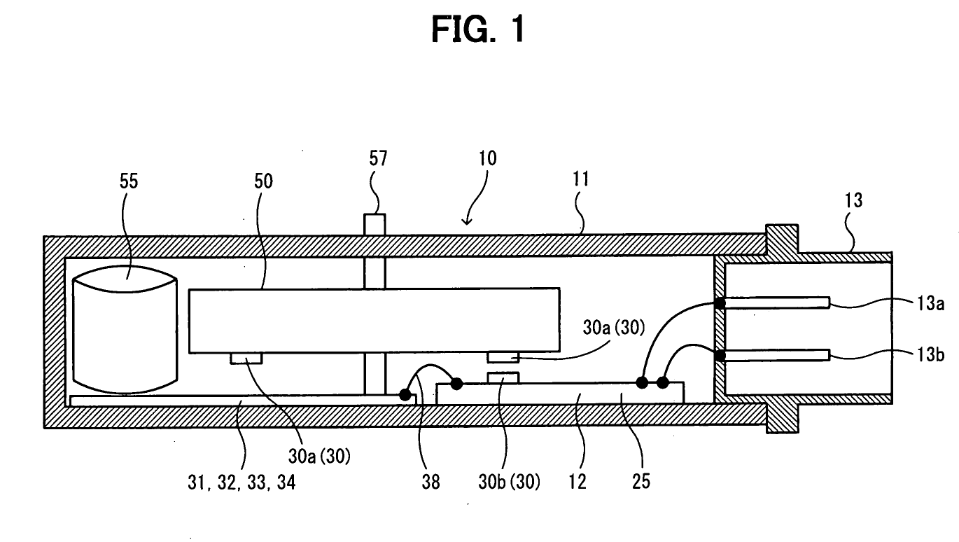

As shown in FIG. 1, an electric motor 10 includes a housing 11. The housing 11 accommodates at least one electronic control circuit. This at least one electronic control circuit constructs an electronic control unit (ECU).

The at least one electronic control circuit includes a shift-by-wire control circuit (SBW control circuit) 12. Specifically, the shift-by-wire control circuit 12 is fixed to the inner wall of the housing 11. The SBW control circuit 12 serves as a control circuit. In this structure, the electric motor 10 and the SBW control circuit 12 are made integral with each other.

The housing 11 is partially or wholly made of a conductive material such as iron, so that influences of noise from outside can be reduced. Thus, an erroneous operation of the SBW control circuit 12 caused by noise from outside can be steadily restricted. Conversely, noise generated inside the housing 11 can be restricted from leaking to outside, so that an external equipment outside of the housing 11 can be restricted from causing an erroneous operation. An interface unit 13 is made integral with the housing 11 to connect the SBW control circuit 12 to an external conductor.

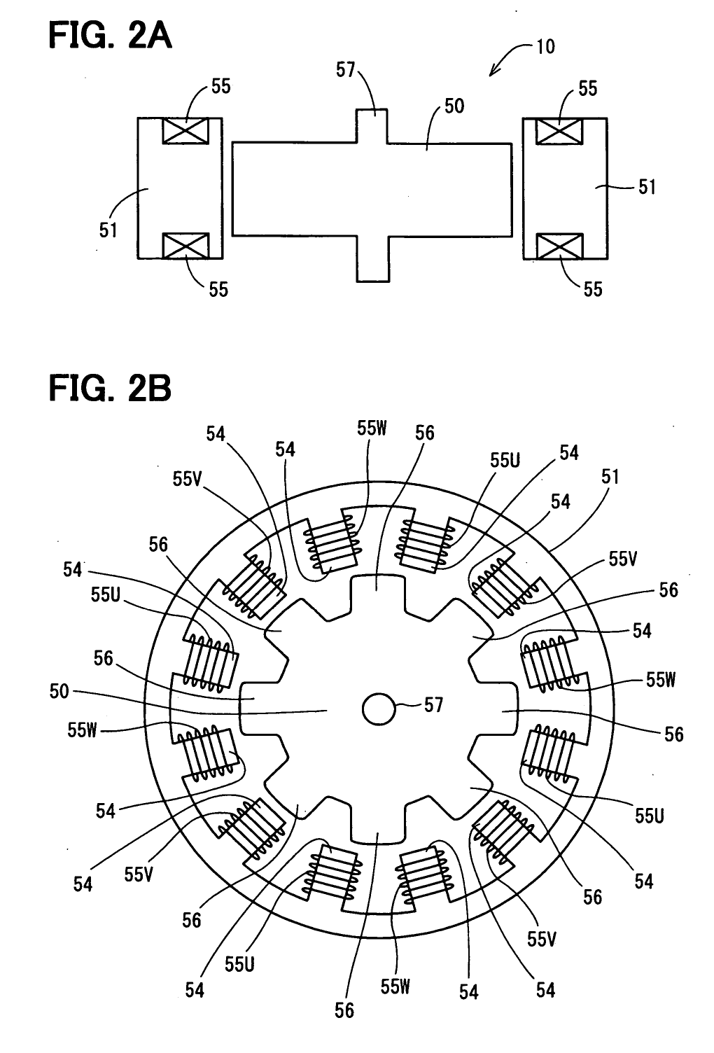

For example, the electric motor 10 is a brushless switched reluctance motor (SR motor) using no permanent magnet. As shown in FIGS. 2A, 2B, the electric motor 10 includes the rotor core 50, the stator core 51, and multiple coils 55U, 55V, and 55W. The rotor core 50 is mounted centrally in the electric motor 10. The stator core 51 surrounds the outer periphery of the rotor core 50. The coils 55U, 55V, and 55W are wound around the stator core 51. Multiple rotor teeth 56 are provided on the rotor core 50 along the rotative direction thereof. The rotor teeth 56 respectively project toward the stator core 51 on the outer peripheral side. In addition, an output shaft 57 is provided to the rotor core 50 to project along the rotation axis of the rotor core 50. Multiple stator core teeth 54 are provided on the stator core 51 along the rotative direction thereof. The stator core teeth 54 respectively project toward the rotor core 50 on the inner peripheral side. The coils 55U, 55V, 55W are wound around the respective stator core teeth 54. The electric motor 10 may further include a reduction mechanism that increases drive force for rotating the output shaft 57 of the electric motor 10.

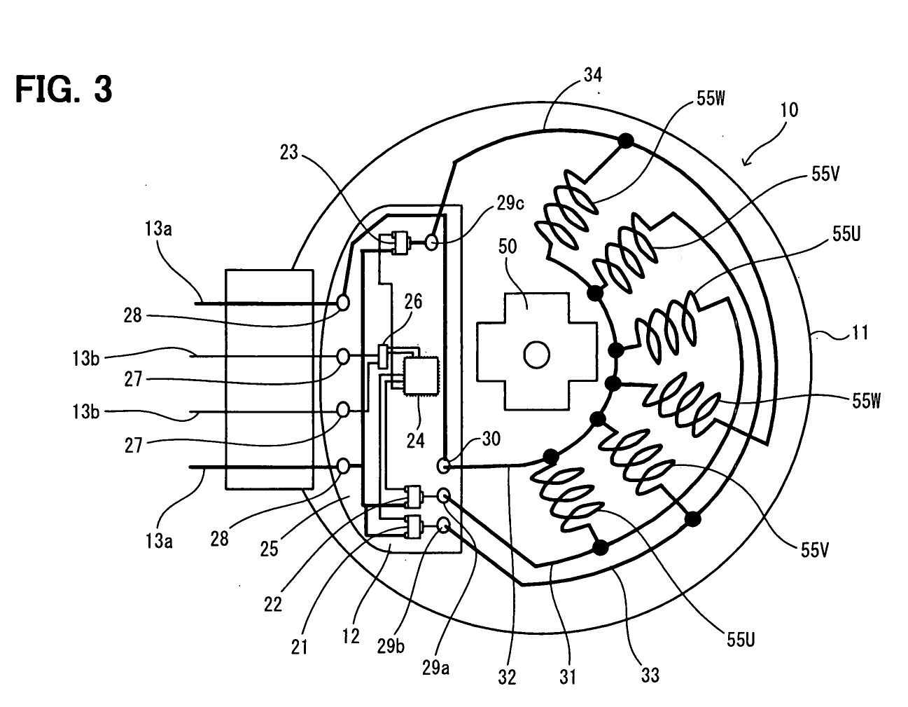

FIG. 2B depicts twelve coils 55U, 55V, 55W in total. However, in FIG. 3, only six coils are depicted for the sake of simplicity. The SBW control circuit 12 makes switching elements 21, 22, 23 ON or OFF to thereby control supplying electric current to the coils 55U, 55V, 55W. The SBW control circuit 12 sequentially switches supplying electric current to the coils 55U, 55V, 55W of U phase, V phase, and W phase, so that the magnetic state of respective magnetic poles of the stator core teeth 54 on the side of the rotor core 50 are sequentially switched over. Thereby, the rotor teeth 56 opposed to the stator core teeth 54 are attracted by the stator core teeth 54, so that the rotor core 50 is rotated. The direction in which the rotor core 50 is rotated is determined in accordance with an order, in which electric current is supplied to the coils 55U of U phase, the coil 55V of V phase, and the coils 55W of W phase. For example, the rotor core 50 is rotated in a forward direction when supplying of electric current is switched over in the order of U phase, V phase, and W phase. By contrast, for example, the rotor core 50 is rotated in a reverse direction when supplying of electric current is switched over in the order of W phase, V phase, and U phase. The actuator is not limited to the brushless SR motor. The actuator may include a motor having a brush or a motor other than a SR motor.

As referred to FIG. 3, the SBW control circuit 12 includes a substrate 25, a control element 24, a communication control element 26, and switching elements 21, 22, 23. The control element 24 is a microcomputer. The communication control element 26 controls communication with other devices via an in-vehicle LAN, for example. The SBW control circuit 12 further includes connecting terminals 29a, 29b, 29c and a power terminal 30. Each of the connecting terminals 29a, 29b, 29c electrically connects each of the coils 55U, 55V, 55W with the corresponding switching element 21, 22, 23. The power terminal 30 electrically connects the respective coils 55U, 55V, 55W with an electric power source. The SBW control circuit 12 serves as a control circuit.

The SBW control circuit 12 further includes connector terminals 27, 28. The connector terminal 27 electrically connects the communication control element 26 with the in-vehicle LAN. The connector terminal 28 electrically connects the electric power source with the substrate 25. The connector terminal 27 and the connector terminal 28, respectively, are connected to connector pins 13a, 13b by wire bonding, for example. The connector pins 13a, 13b are provided on the interface unit 13.

Subsequently, a conductor for electrically connecting the SBW control circuit 12 with the electric motor 10 is described. As shown in FIG. 3, one electrode of the coil 55U is connected to the connecting terminal 29a via a conductor 31. The other electrode of the coil 55U is connected to the power terminal 30 via a conductor 32. One electrode of the coil 55V is connected to the connecting terminal 29b via a conductor 33. The other electrode of the coil 55V is connected to the power terminal 30 via the conductor 32. One electrode of the coil 55W is connected to the connecting terminal 29c via a conductor 34. The other electrode of the coil 55W is connected to the power terminal 30 via the conductor 32.

Specifically, the conductors 31 to 34 include a bus bar, for example. The bus bar may be a plate-shaped conductor formed of a conductive material such as metal, and hard to suffer breakage. Accordingly, the application of the bus bar for the conductors 31 to 34 can improve reliability thereof. As referred to FIG. 1, the respective bus bars extend to the vicinity of the substrate 25. As referred to FIG. 3, the bus bars connect to the connecting terminals 29a, 29b, and 29c, and the power terminal 30 via a wire bonding 38 (FIG. 1).

As referred to FIG. 1, an encoder 30 includes multiple magnets 30a and a hall element 30b. The magnets 30a are mounted along the rotative direction of the rotor core 50. The hall element 30b is provided on the substrate 25 to face the magnets 30a, for example, for detecting magnetism.

The hall element 30b serves as a sensor. In this embodiment, the encoder 30 is a digital encoder that makes addition and subtraction of the number of pulses corresponding to a rotation angle of the rotor core 50. The hall element 30b is provided on the substrate 25, so that an exclusive substrate for the hall element 30b can be omitted. Thus, the number of components can be reduced. In addition, an exclusive substrate for the hall element 30b is omitted, so that a connector need not be additionally provided for electrically connecting the exclusive substrate for the hall element 30b with the substrate 25. Thereby, reliability can be further enhanced.

Subsequently, a radiating structure of a heat emitting element is described. A switching element is described as an example of the heat emitting element.

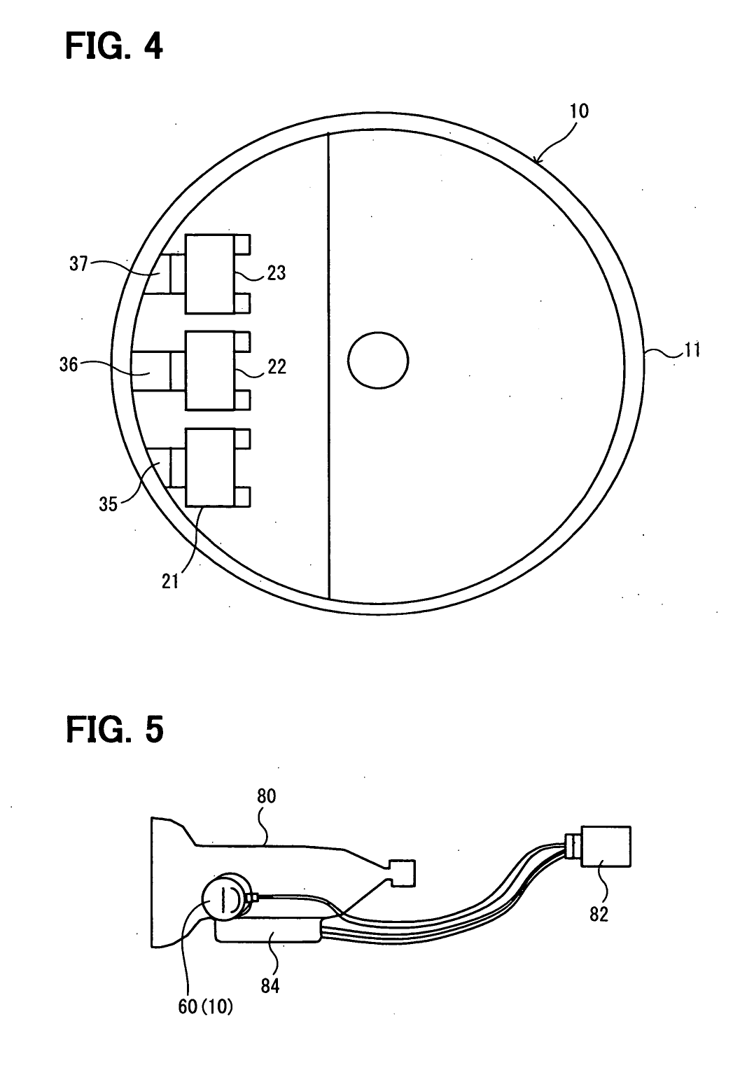

In FIG. 4, the switching elements 21, 22, 23 are largely depicted for the sake of easy understanding. Furthermore, in FIG. 4, components such as elements on the SBW control circuit 12 other than the switching elements 21, 22, 23 are not depicted. The rotor core 50 is also not depicted in FIG. 4.

The switching elements 21, 22, 23 respectively make contact with the housing 11 via metallic members 35, 36, 37. In this structure, heat of the switching elements 21, 22, 23 is released to the housing 11 via the metallic members 35, 36, 37. Thereby, radiating fins mounted to the respective switching elements can be reduced or downsized. Alternatively, when radiating fins are provided, and the radiating fins are the same in size, a further inexpensive heat emitting element can be applied since heat can be released to the housing 11 thereby improving efficiency in radiation.

In this example structure, the respective switching elements are made to contact with the housing 11 via the metallic members. However, the respective switching elements may be made to contact with the stator core 51 of the electric motor 10 via the metallic members. The respective switching elements may be made to contact with the housing 11 or the electric motor 10 via a radiating member or the substrate instead of the metallic members. The respective switching elements may be arranged closely to the housing 11 and the components of the electric motor 10, instead of being made to contact therewith. Each of the switching elements 21, 22, 23 is an example of a heat emitting element. The heat emitting element may include the control element 24.

Subsequently, a shift-by-wire system is described. The shift-by-wire system includes the electric motor 10 and the SBW control circuit 12. The shift-by-wire system may serve as a vehicle control system.

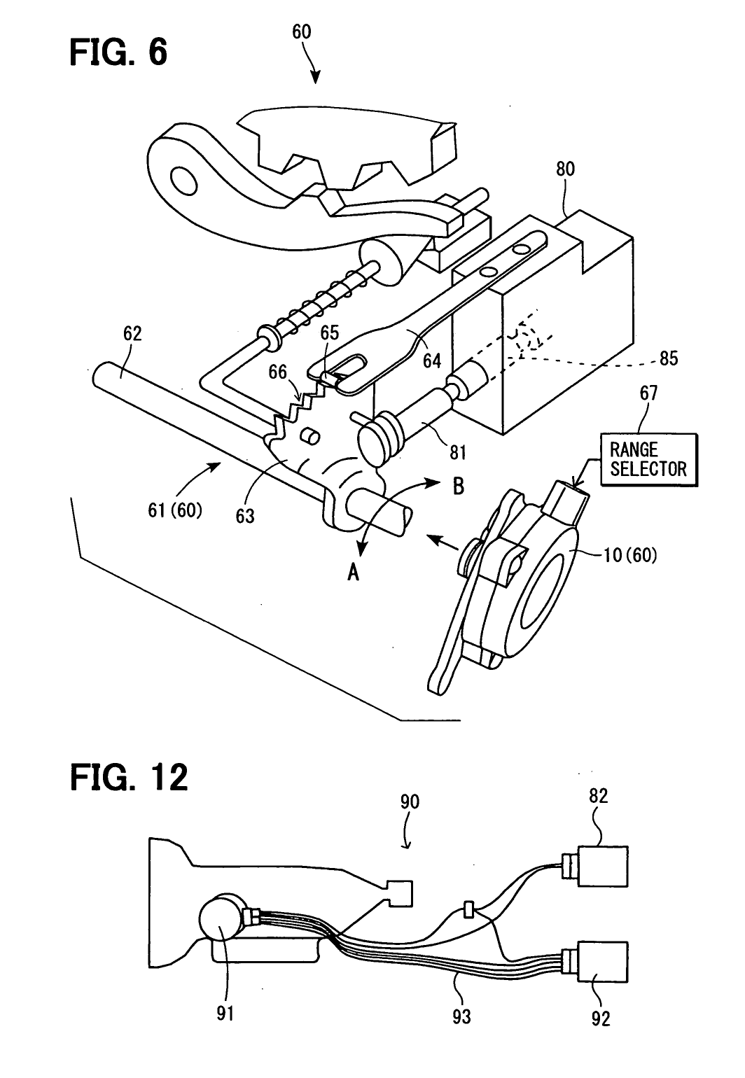

As shown in FIGS. 5, 6 the automatic transmission 80 includes multiple friction engagement elements (not shown) clamped in any one of shift ranges.

An automatic transmission controller controls the automatic transmission 80. The automatic transmission controller includes multiple electromagnetic valves (not shown), a manual valve 85, and an automatic transmission control circuit (AT control circuit) 82.

This AT control circuit 82 is included in the at least one electronic control circuit that constructs the ECU. This AT control circuit 82 also serves as a control circuit. The electromagnetic valves (not shown) are accommodated in an oil pan 84 for controlling hydraulic pressure applied to the friction engagement elements.

The shift-by-wire system 60 is connected to an automatic transmission. As referred to FIG. 6, a spool 81 is movably provided on the manual valve 85. The automatic transmission 80 has travel ranges such as a forward (D) range, a backward (R) range, a parking (P) range, and a neutral (N) range. The parking (P) range and neutral (N) range serve as non-travel ranges. When the spool 81 is axially moved, the automatic transmission 80 is switched over in shift range position according to the position of the spool 81. The AT control circuit 82 electrically controls the respective electromagnetic valves to increase or decrease hydraulic pressure applied to the friction engagement elements thereby switching over the friction engagement elements between engagement and disengagement. By the switching over the friction engagement elements between engagement and disengagement, the automatic transmission 80 is switched over in the shift ranges.

The shift-by-wire system 60 includes the electric motor 10, a conversion mechanism 61, and a range detector (not shown). The electric motor 10 is made integral with the SBW control circuit 12. The conversion mechanism 61 converts rotating drive force of the electric motor 10 into linear drive force to axially move the spool 81. The range detector (not shown) detects a present shift range position of the automatic transmission 80. The SBW control circuit 12 is connected to a range selector 67. A vehicle passenger selects a shift range via the range selector 67. The range selector 67 outputs a shift range switchover instruction to the SBW control circuit 12 for instructing switchover to an instructed shift range having been selected by the vehicle passenger. The range selector 67 is connected to the AT control circuit 82, so that the AT control circuit 82 is capable of outputting the shift range instruction to the SBW control circuit 12. The shift range instruction represents the shift range selected by the vehicle passenger.

The conversion mechanism 61 includes a control rod 62, a detent plate 63, a detent spring 64, and a roller 65. The control rod 62 is substantially perpendicular to the axis of the spool 81. One end of the control rod 62 with respect to the axial direction thereof is connected to the electric motor 10. The detent plate 63 is fixed to the control rod 62 to turn together with the control rod 62. The detent spring 64 is a blade spring supported by a cantilever at a predetermined fixing portion. The detent spring 64 biases the roller 65 toward the detent plate 63. The roller 65 is mounted at a tip end of the detent spring 64. The spool 81 engages with the detent plate 63. The spool 81 axially moves when the detent plate 63 turns. The detent plate 63 is a member in the form of a substantially arcuate-shaped plate. The detent plate 63 has multiple recesses 66 formed on the arcuate-shaped outer periphery thereof. Each of the recesses 66 corresponds to one of the shift range positions of the automatic transmission 80. When the spool 81 is moved, the shift range position of the automatic transmission 80 is switched over corresponding to the position of the spool 81. At this time, one of the recesses 66, which corresponds to the shift range position, and the roller 65 engage with each other, so that the detent plate 63 is restricted from turning.

Subsequently, the operation of the shift-by-wire system 60 is described.

The range selector 67 outputs shift range switchover instructions, so that the SBW control circuit 12 controls the rotation of the electric motor 10 in accordance with the number of the pulse count, which corresponds to the number of pulses output by the encoder 30. Specifically, the SBW control circuit 12 rotates the electric motor 10 while referring to the number of the pulse count, which corresponds to the rotation angle of the rotor core 50. The SBW control circuit 12 stops rotation of the electric motor 10 when a target number of the pulse count is achieved. Thus, the SBW control circuit 12 turns the detent plate 63 to a position corresponding to the shift range (instructed shift range) on the basis of the shift range switchover instructions.

When the electric motor 10 rotates within a range of a predetermined number of the pulse count, in which the target number of the pulse count is included, the SBW control circuit 12 evaluates whether a shift range detection signal of the shift range detector changes to the state corresponding to the instructed shift range. When the shift range detection signal changes to the state corresponding to the instructed shift range, the SBW control circuit 12 determines switchover to the instructed shift range position to be made and stops supplying electric current to the electric motor 10.

With the shift-by-wire system 60 according to this embodiment, the SBW control circuit 12 is fixed to the housing 11 whereby the electric motor 10 and the SBW control circuit 12 are made integral with each other. For example, when the electric motor 10 and the SBW control circuit 12 are made independently, an additional connector becomes necessary for electrically connecting the electric motor 10 with the SBW control ECU 12 via a conductive wire. By contrast, in the above structure, the electric motor 10 and the SBW control circuit 12 are made integral with each other, so that the electric motor 10 can be directly connected with the SBW control circuit 12 via a conductive wire. Thus, an additional connector need not be provided. Consequently, the number of connectors, which are high in failure rate, can be reduced, so that the shift-by-wire system 60 can be improved in reliability.

Further, the electric motor 10 and the SBW control circuit 12 are made integral with each other, so that a manufacturing work for electrically connecting the electric motor 10 with the SBW control circuit 12 can be facilitated. A manufacturing work for laying a wire harness or the like can be reduced, so that mount quality and assembly quality can be improved.

Furthermore, the electric motor 10 and the SBW control circuit 12 are improved in reliability by reducing the number of connectors, so that the construction of the electric motor 10 and the SBW control circuit 12 can be simplified. Therefore, the number of components is not increased and reliability of the shift-by-wire system 60 can be improved while downsizing the shift-by-wire system 60. Therefore, the shift-by-wire system 60 becomes small in size, high in reliability, and excellent in mount quality.

Further, the SBW control circuit 12 is accommodated in the housing 11 of the shift-by-wire system 60, so that the conductor need not be taken to the outside the housing 11. Therefore, the conductor can be restricted from being pinched by components constructing the vehicle, so that the conductor can be restricted from causing breakage and short circuit. Thus, reliability of the shift-by-wire system 60 can be improved.

Further, the electric motor 10 and the SBW control circuit 12 are made integral with each other in the shift-by-wire system 60, so that the conductor can be shortened. The conductor may become an antenna receiving noise. In this structure, the conductor can be shortened, so that an erroneous operation of the SBW control circuit 12 due to influences of noise can be reduced. Thus, reliability of the SBW control circuit 12 can be improved.

Further, the electric motor 10 and the SBW control circuit 12 are made integral with each other to decrease a distance between the electric motor 10 and the SBW control circuit 12. Therefore, the conductor is decreased in resistance, so that the shift-by-wire system 60 is totally improved in energy efficiency.

The bus bar is an example of the conductor. The conductor may include a wire harness.

### Second Embodiment

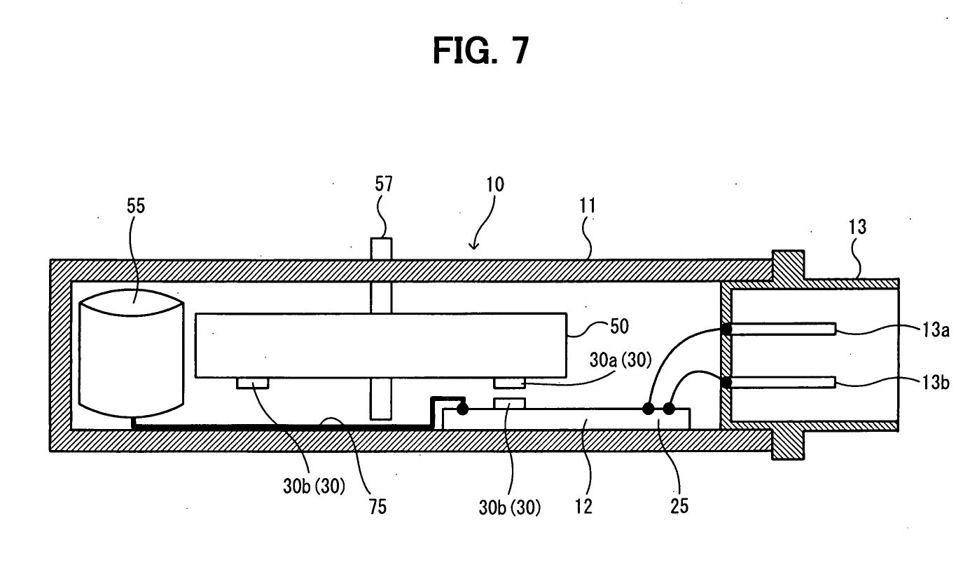

As shown in FIG. 7, according to the second embodiment, the coils 55U, 55V, 55W of the electric motor 10 are electrically connected with the SBW control circuit 12 via a wire harness 75 as a conductor. The wire harness 75 is fixed to the inner wall face of the housing 11 via adhesion, for example. In this structure, the wire harness 75 can be restricted from being pinched by a component accommodated in the housing 11, so that the wire harness 75 can be restricted from causing breakage and short circuit. Thus, reliability of the shift-by-wire system 60 can be improved.

In this example structure, the wire harness 76 is fixed as a conductor. Alternatively, a bus bar may be fixed when the bus bar constructs the conductor.

In addition, when the hall element 30b is provided on an area excluding the substrate 25, the conductor is preferably fixed to the inner wall face of the housing 11 such that the conductor connects the hall element 30b with the SBW control circuit 12. In this structure, the conductor, which connects the hall element 30b with the SBW control circuit 12, can be restricted from causing breakage and short circuit due to being pinched by another component.

### Third Embodiment

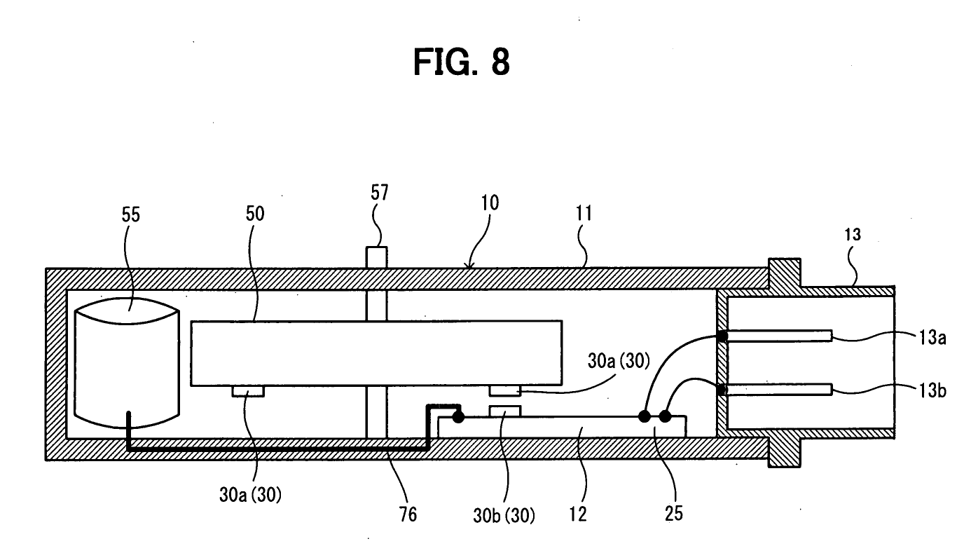

As shown in FIG. 8, according to the third embodiment, the electric motor 10 and the SBW control circuit 12 are connected to each other via a wire harness 76 as a conductor. The wire harness 76 is embedded in the housing 11 by insert molding, for example. In this structure, the wire harness 76 can be restricted from causing breakage and short circuit due to being pinched by another component accommodated in the housing 11. Thus, reliability of the shift-by-wire system 60 can be improved.

In this example structure, the wire harness 76 is embedded in the housing 11, as a conductor. Alternatively, in a structure in which a bus bar constructs the conductor, the bus bar may be embedded in the housing 11.

In addition, when the hall element 30b is to be provided on an area excluding the substrate 25, the conductor, which connects the hall element 30b with the SBW control circuit 12, is preferably embedded in the housing 11 likewise. In this structure, the conductor, which connects the hall element 30b with the SBW control circuit 12, can be restricted from causing breakage and short circuit due to being pinched by other components.

### Fourth Embodiment

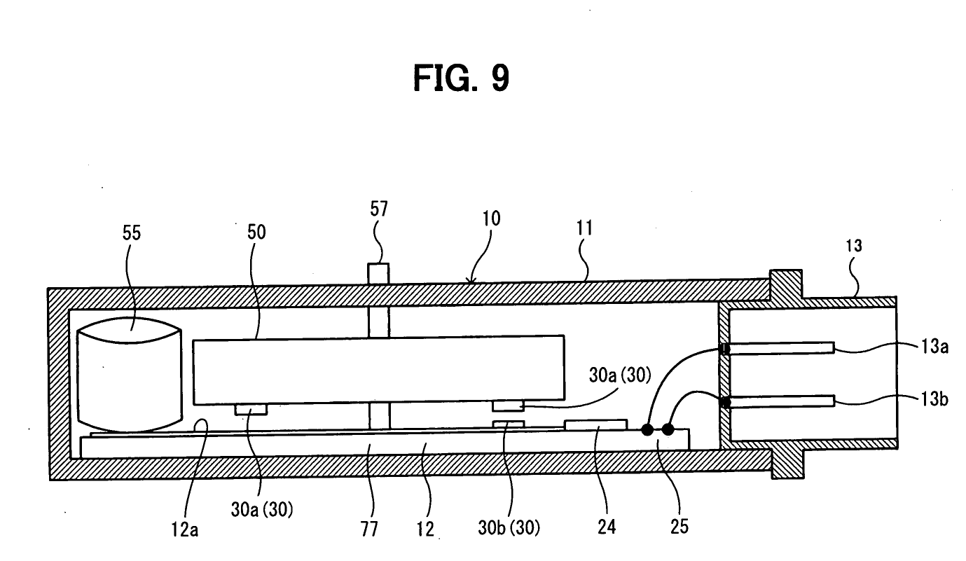

As shown in FIG. 9, according to the fourth embodiment, coils 55U, 55V, 55W of the electric motor 10 are electrically connected with the SBW control circuit 12 via a conductive wire 12a formed on a substrate 77. The conductive wire 12a is a printed circuit, for example. In this structure, the conductive wire 12a can be restricted from causing breakage and short circuit due to being pinched by another component accommodated in the housing 11.

### Fifth Embodiment

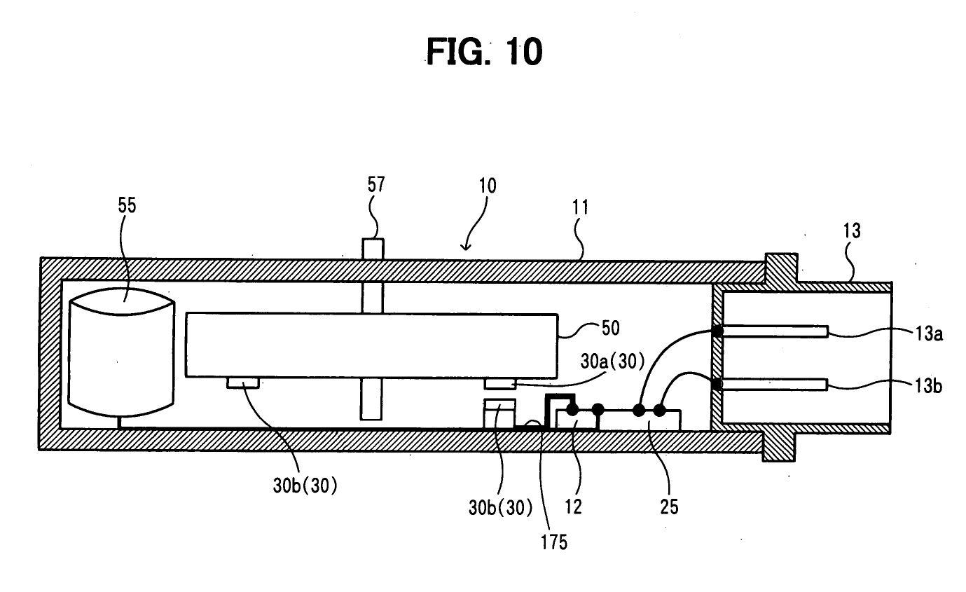

As shown in FIG. 10, according to the fifth embodiment, the hall element 30b and the SBW control circuit 12 are connected to each other via a wire harness 175 as a conductor. The wire harness 175 is fixed to the inner wall face of the housing 11 via adhesion, for example. In this structure, the wire harness 175 can be restricted from being pinched by a component accommodated in the housing 11, so that the wire harness 75 can be restricted from causing breakage and short circuit, similarly to the structure in the second embodiment. Thus, reliability of the shift-by-wire system 60 can be improved.

The wire harness 75 in the second embodiment may be provided to the electric motor 10 such that the wire harness 75 is fixed to the housing 11, as a conductor.

### Sixth Embodiment

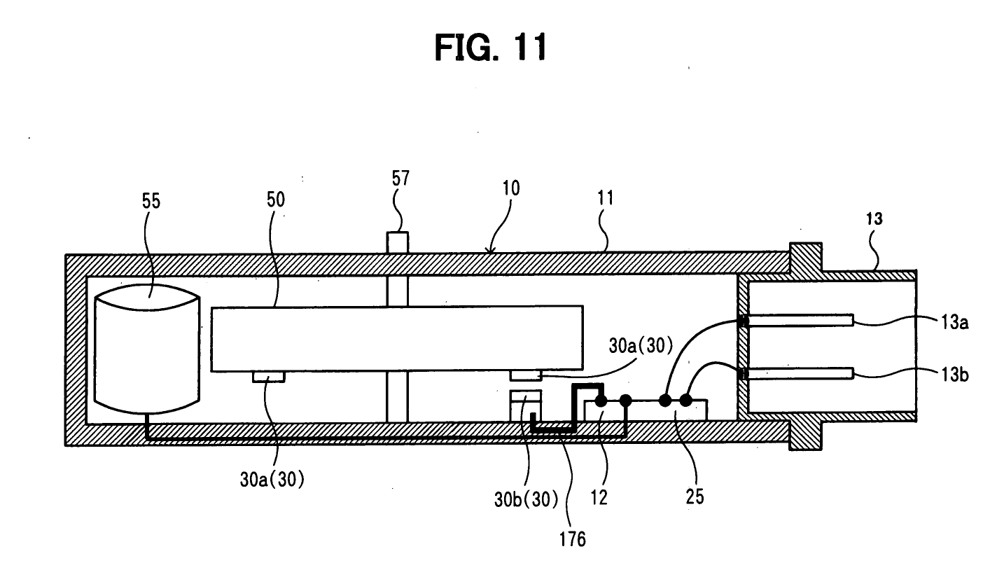

As shown in FIG. 11, according to the sixth embodiment, the hall element 30b and the SBW control circuit 12 are connected to each other via a wire harness 176 as a conductor. The wire harness 176 is embedded in the housing 11 by insert molding, for example. In this structure, the wire harness 176 can be restricted from causing breakage and short circuit due to being pinched by another component accommodated in the housing 11, similarly to the structure in the third embodiment. Thus, reliability of the shift-by-wire system 60 can be improved.

The wire harness 76 in the third embodiment may be provided to the electric motor 10 such that the wire harness 76 is embedded in the housing 11, as a conductor.

In the above embodiments, the shift-by-wire system (vehicle control system) is used for the automatic transmission 80 that is operated in accordance with the shift range position switched by the passenger. The vehicle control system 60 includes the actuator and the control circuit 12. The actuator manipulates the shift range position. The control circuit 12 controls the actuator such that the shift range position coincides with an instruction provided by the passenger. The actuator and the control circuit (12) are integrated.

The above structures of the embodiments can be combined as appropriate.

Various modifications and alternations may be diversely made to the above embodiments without departing from the spirit of the present invention.

What is claimed is:

1. A vehicle control system for an automatic transmission, the vehicle control system comprising:
an actuator that manipulates the automatic transmission to switch a shift range position of the automatic transmission; and
a control circuit that controls the actuator such that the shift range position coincides with an instruction provided by the passenger, wherein the actuator and the control circuit are integrated.

2. The vehicle control system according to claim 1, wherein the actuator includes a housing.

3. The vehicle control system according to claim 2, wherein the housing accommodates the control circuit.

4. The vehicle control system according to claim 3, wherein the housing is conductive.

5. The vehicle control system according to claim 2 further comprising:
a conductor that is fixed to the housing for electrically connecting the actuator with the control circuit.

6. The vehicle control system according to claim 2 further comprising:
a conductor that is embedded in the housing for electrically connecting the actuator with the control circuit.

7. The vehicle control system according to claim 1,
wherein the control circuit includes a substrate and a conductive wire,
the conductive wire is arranged on the substrate, and
the actuator electrically connects with the control circuit via the conductive wire.

8. The vehicle control system according to claim 1,
wherein the control circuit includes a heat emitting element,
the actuator includes at least one component for radiating heat from the heat emitting element,
the heat emitting element is in one of the following conditions:
the heat emitting element is in contact with the at least one component; and
the heat emitting element is in the vicinity of the at least one component.

9. The vehicle control system according to claim 8, wherein the at least one component includes a housing that accommodates the control circuit.

10. The vehicle control system according to claim 9, wherein the at least one component includes a metallic member connecting the heat emitting element with the housing.

11. The vehicle control system according to claim 1, further comprising:
a sensor that detects a state of the actuator, the sensor outputting a detection signal to the control circuit in accordance with the state of the actuator,
wherein the control circuit controls the actuator on the basis of the detection signal of the sensor.

12. The vehicle control system according to claim 11, wherein the actuator includes a housing.

13. The vehicle control system according to claim 12, wherein the housing accommodates the control circuit and the sensor.

14. The vehicle control system according to claim 12, further comprising:
a conductor that is fixed to the housing for electrically connecting the sensor with the control circuit.

15. The vehicle control system according to claim 12, further comprising:
a conductor that is embedded in the housing for electrically connecting the sensor with the control circuit.

16. The vehicle control system according to claim 11,
wherein the control circuit includes a substrate, and
the sensor is provided to the substrate.

17. The vehicle control system according to claim 1,
wherein the actuator includes a rotor that is in a substantially disc-shape, the rotor having a flat face, and
the control circuit includes a substrate that is substantially in parallel with the flat face of the rotor.

18. The vehicle control system according to claim 17, further comprising:
a sensor that is provided on the substrate for detecting rotation of the rotor,
wherein the sensor faces to a predetermined portion of the rotor.

19. An automatic transmission system for a vehicle, the automatic transmission system comprising:
an automatic transmission;
an actuator that operates a shift range position of the automatic transmission; and
a control circuit that controls the actuator such that the shift range position coincides with an instruction provided by a passenger,
wherein the actuator includes a housing that accommodates the control circuit.

20. The automatic transmission system according to claim 19,
wherein the actuator further includes a rotor and a coil,
the housing accommodates the rotor and the coil, and
the rotor is rotated by supplying electricity to the coil thereby actuating the automatic transmission.

21. The automatic transmission system according to claim 20, further comprising:
a conductor that is accommodated in the housing, the conductor electrically connecting the control circuit with the coil.
